(19) United States
(12) Patent Application Publication
(10) Pub. No.: US 2010/0009129 A1
(43) Pub. Date: Jan. 14, 2010

(54) Ribbon band

(76) Inventor: Yuan-Jung Tsai, Nantou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,856

(22) Filed: Jul. 11, 2008

(51) Int. Cl. B32B 15/00

(52) U.S. Cl. 428/192

(57) ABSTRACT

A ribbon band includes a base band and two trim strips respectively bonded to two opposite lateral sides of the base band with an outer line of weld seal and an inner line of weld spots, and two metal wires embedded between the base band and the trim strips.

### BACKGROUND OF THE INVENTION

1. Field of the Invention

The present invention relates to ribbon bands and more particularly, to such a ribbon band that can be bent into and kept in any desired shape.

2. Description of the Related Art

Regular ribbon bands are commonly made of chemical fibers by weaving. During the fabrication of a ribbon band, the two opposite rough edges of the ribbon band are fastened with trim strips to prevent unraveling.

FIG. 1 shows a ribbon band according to the prior art. According to this design, the two opposite lateral sides of the base band 1 are covered with zigzag stitches 2 to prevent unraveling. This ribbon band fabrication procedure requires much labor and time.

FIG. 2 shows another structure of ribbon band according to the prior art. According to this design, two trim strips 4 are folded up and respectively covered on the two opposite lateral sides of the base band 3 and then sealed thereto by means of thermal fusion. The process of sealing the trim strips 4 to the base band 3 through a full-surface thermal fusion process requires much fusion time. Further, this planar sealing shows no variation in pattern, i.e., this design of ribbon band is monotonous and less attractive.

### SUMMARY OF THE INVENTION

The present invention has been accomplished under the circumstances in view. It is one object of the present invention to provide a ribbon band that improves the fabrication efficiency. It is one object of the present invention to provide a ribbon band that can be bent into and kept in any desired shape.

To achieve these and other objects of the preset invention, the ribbon band comprises a narrow elongated base band, two trim strips respectively covered on the top surface of the narrow elongated base band and extending along the two opposite long sides of the narrow elongated base band, two lines of weld seal formed on the trim strips and the narrow elongated base band to seal the trim strips to the narrow elongated base band and to cut off rough edges, two lines of weld spots formed the trim strips and the narrow elongated base band to seal the trim strips to the narrow elongated base band, and two metal wires respectively embedded between the trim strips and the narrow elongated base band.

### BRIEF DESCRIPTION OF THE DRAWINGS

FIG. 1 is a plain view of a ribbon band according to the prior art.

FIG. 2 is an exploded view of another structure of ribbon band according to the prior art.

FIG. 3 is an exploded view of a ribbon band in accordance with the present invention.

FIG. 4 is a perspective view of a semi-finished product of the ribbon band according to the present invention.

FIG. 4A is an enlarged view of a part of FIG. 4.

FIG. 5 is a perspective view of the finished product of ribbon band according to the present invention.

FIG. 6 is a cross sectional view of FIG. 5.

FIG. 7 is a perspective view of a semi-finished product of an alternate form of the ribbon band according to the present invention.

FIG. 8 is a perspective view of the finished product of the alternate form of ribbon band according to the present invention.

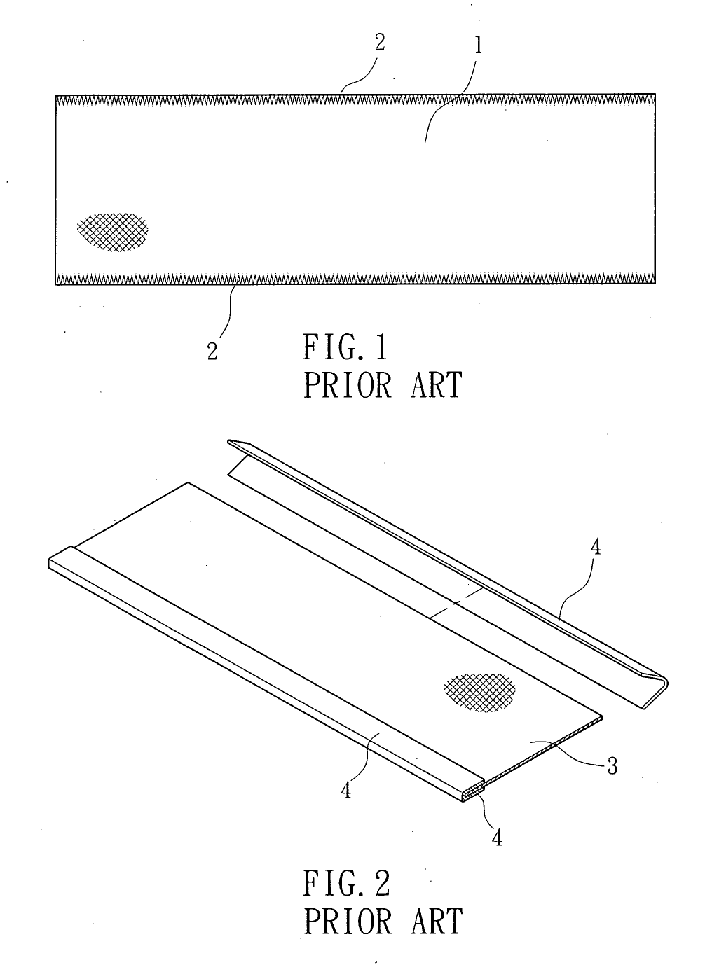

### DETAILED DESCRIPTION OF THE PREFERRED EMBODIMENT

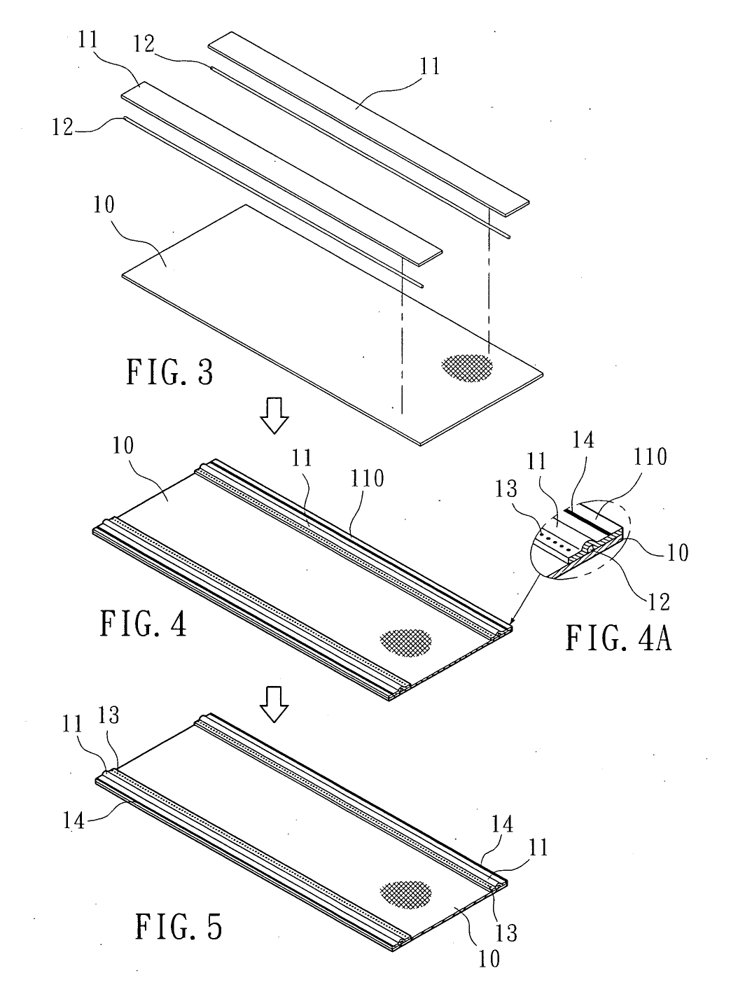

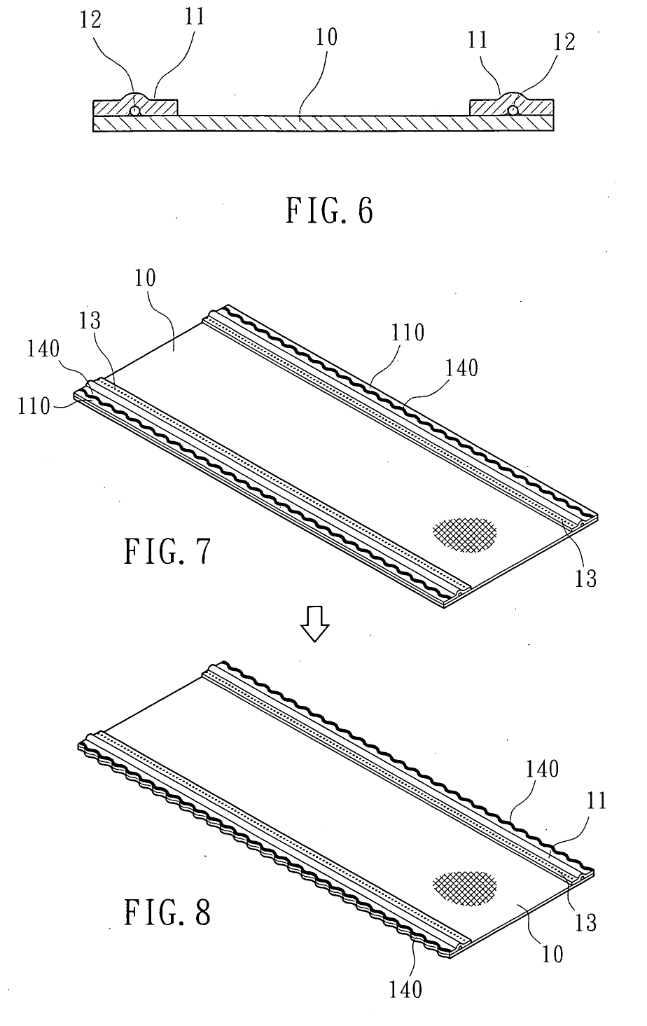

Referring to FIGS. 3˜6, a ribbon band in accordance with the present invention is shown comprising a narrow elongated base band 10, two trim strips 11 bonded to one side of the base band 10 by means of thermal fusion and respectively extending along two opposite lateral sides of the base band 10, and two metal wires 12 respectively embedded between the base band 10 and the trim strips 11.

During fabrication, the base band 10 is put in a heat sealing apparatus, and then the metal wires 12 are placed on the top surface of the base band 10 and extended in longitudinal direction in a parallel manner near the two opposite lateral sides of the base band 10, and then the two trim strips 11 are respectively covered on the base band 10 over the metal wires 12, and then the top and bottom heat-sealing wheels of the heat sealing apparatus are respectively rotated over the base band 10 and the trim strips 11, forming a line of weld seal 14 and a line of weld spots 13 at two sides relative to each metal wire 12.

As shown in FIGS. 4 and 5, the line of weld seal 14 is a solid line of weld seal disposed at an outer side so that the respective rough edge 110 is cut off. The line of weld spots 13 has the trim strips 11 be bonded to the base band 10 at spots so that the trim strips 11 and the base band 10 will not be cut off during thermal fusion.

Because the metal wires 12 are embedded between the base band 10 and the trim strips 11, the ribbon band can be bent into and kept in any desired shape.

FIGS. 7 and 8 show an alternate form of the present invention. According to this alternate form, the base band 10 and each trim strip 11 are processed through a thermal fusion process, forming a wave-like line of weld seal 140 and a line of weld spots 13 at two sides relative to the associating metal wire 12.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A ribbon band, comprising:
a narrow elongated base band, said narrow elongated base band having two opposite long sides;
two trim strips respectively covered on a top surface of said narrow elongated base band and extending along the two opposite long sides of said narrow elongated base band;
two lines of weld seal formed on said trim strips and said narrow elongated base band to seal said trim strips to said narrow elongated base band and extending along the two opposite long sides of said narrow elongated base band; and
two lines of weld spots formed said trim strips and said narrow elongated base band to seal said trim strips to said narrow elongated base band and spaced between said two lines of weld seal.

2. The ribbon band as claimed in claim 1, further comprising two metal wires respectively embedded in between said trim strips and said narrow elongated base band.
